(19) United States
(12) Patent Application Publication
(10) Pub. No.: US 2025/0286823 A1
(43) Pub. Date: Sep. 11, 2025

(54) Selective retransmission mechanisms

(71) Applicant: Mellanox Technologies, Ltd., Yokneam (IL)

(72) Inventors: Yamin Friedman, Jerusalem (IL); Idan Borshteen, Carmiel (IL); Ariel Shahar, Jerusalem (IL); Roee Moyal, Yoqneam Ilit (IL); Shay Aisman, Zichron Yaacov (IL); Diego Crupnicoff, Buenos Aires (AR); Yuval Shpigelman, Netanya (IL)

(21) Appl. No.: 19/050,153

(22) Filed: Feb. 11, 2025

Related U.S. Application Data
(60) Provisional application No. 63/561,345, filed on Mar. 5, 2024.

(51) Int. Cl. H04L 47/2466; H04L 1/1607

(52) U.S. Cl. CPC H04L 47/2466; H04L 1/1614

(57) ABSTRACT

In one embodiment, a responder device includes a network interface to receive packets of a stream of packets transmitted from a requester device with packet sequence numbers, and packet processing circuitry to collect information about the packet sequence numbers of the packets that have been received from the requester device, generate a selective acknowledgement including an indication of the packet sequence numbers of at least one packet of the packets that has been received and at least one other packet of the packets that has not been received by the responder device from the requester device, wherein the at least one packet that has been received by the responder device includes at least one of the packets received out-of-order according to the packet sequence numbers, and send the selective acknowledgement to the requester device via the network interface.

### RELATED APPLICATION INFORMATION

The present application claims benefit of U.S. Provisional Patent Application Ser. No. 63/561,345 of Friedman, et al., filed 5 Mar. 2024, the disclosure of which is hereby incorporated herein by reference.

### FIELD OF THE DISCLOSURE

The present disclosure relates to computer systems, and in particular, but not exclusively to, retransmission mechanisms.

### BACKGROUND

Data transmission in network environments often encounters challenges related to packet loss and delay. Traditional methods for handling packet loss, such as those used in lossless environments, may not perform efficiently in lossy networks. These methods typically involve resending packets if an acknowledgment is not received within a specified timeout period, which can lead to inefficiencies.

### OVERVIEW

There is provided in accordance with an embodiment of the present disclosure, a responder device, including a network interface to receive packets of a stream of packets transmitted from a requester device with packet sequence numbers, and packet processing circuitry to collect information about the packet sequence numbers of the packets that have been received from the requester device, generate a selective acknowledgement including an indication of the packet sequence numbers of at least one packet of the packets that has been received, and at least one other packet of the packets that has not been received by the responder device from the requester device, wherein the at least one packet that has been received by the responder device includes at least one of the packets received out-of-order the packet sequence numbers, and send the selective acknowledgement to the requester device via the network interface.

Further in accordance with an embodiment of the present disclosure the packet processing circuitry is to include a bitmap in the selective acknowledgement to indicate the packet sequence numbers of the at least one packet that has been received and the at least one other packet that has not been received by the responder device from the requester device, and include an indication of a base packet sequence number of one of the packets in the selective acknowledgement from which the packet sequence numbers of the packets indicated by the bitmap are derived.

Still further in accordance with an embodiment of the present disclosure the packet processing circuitry is to include a packet sequence number list and/or at least one packet sequence number range in the selective acknowledgement to indicate the packet sequence numbers of the at least one packet that has been received and the at least one other packet that has not been received by the responder device from the requester device.

Additionally in accordance with an embodiment of the present disclosure the packet processing circuitry is to collect information about the arrival times of the received packets, and include the at least one of the arrival times in the selective acknowledgement.

Moreover, in accordance with an embodiment of the present disclosure the packets are remote direct memory access (RDMA) packets.

Further in accordance with an embodiment of the present disclosure the packets are remote direct memory access (RDMA) over converged Ethernet (RoCE) version 2 (v2) packets.

There is also provided in accordance with another embodiment of the present disclosure, a requester device, including a network interface to send packets with packet sequence numbers to a responder device over a network, and packet processing circuitry to receive from the responder device a selective acknowledgement including an indication of the packet sequence numbers of at least one packet of the packets that has been received, and at least one other packet of the packets that has not been received by the responder device from the requester device, wherein the at least one packet that has been received by the responder device includes at least one of the packets received out-of-order the packet sequence numbers, analyze the selective acknowledgement to determine a status of a given packet that has not yet been received by the responder device, and retransmit to the responder device via the network interface the given packet based on the analysis of the selective acknowledgement.

Still further in accordance with an embodiment of the present disclosure the selective acknowledgement includes a bitmap to indicate the packet sequence numbers of the at least one packet that has been received and the at least one other packet that has not been received by the responder device from the requester device, the selective acknowledgement indicates of a base packet sequence number of one of the packets, the packet processing circuitry is to derive the packet sequence numbers of the packets indicated by the bitmap from the base packet sequence number, and the packet processing circuitry is to analyze the bitmap to identify the packet sequence numbers of the at least one packet that has been received and the at least one other packet that has not been received by the responder device from the requester device.

Additionally in accordance with an embodiment of the present disclosure the selective acknowledgement includes a packet sequence number list and/or at least one packet sequence number range in the selective acknowledgement to indicate the packet sequence numbers of the at least one packet that has been received and the at least one other packet that has not been received by the responder device from the requester device.

Moreover, in accordance with an embodiment of the present disclosure the selective acknowledgment includes at least one arrival time of at least one of the packets, and the packet processing circuitry is to analyze the at least one arrival time to determine the status of the given packet that has not yet been received by the responder device from the requester device.

Further in accordance with an embodiment of the present disclosure the packet processing circuitry is to analyze the selective acknowledgement and estimate that the given packet that has not yet been received by the responder device from the requester device has been dropped based on the given packet being transmitted via a same path in the network to another one of the packets indicated as having been received by the responder device from the requester device in the selective acknowledgement.

Still further in accordance with an embodiment of the present disclosure the packet processing circuitry is to analyze the selective acknowledgement and estimate that the given packet that has not yet been received by the responder device from the requester device has been dropped, based on age of the given packet on the network.

Additionally in accordance with an embodiment of the present disclosure the packet processing circuitry is to analyze the selective acknowledgement and estimate that the given packet that has not yet been received by the responder device from the requester device has been dropped, based on a difference between (a) a transmission time of the given packet, and (b) a transmission time of another one of the packets indicated as having been received by the responder device from the requester device in the selective acknowledgement, being larger than a threshold time period.

Moreover in accordance with an embodiment of the present disclosure the packet processing circuitry is to analyze the selective acknowledgement and estimate that the given packet that has not yet been received by the responder device from the requester device has been dropped, based on a difference between (a) a packet sequence number of the given packet, and (b) a packet sequence number of another one of the packets indicated as having been received by the responder device from the requester device in the selective acknowledgement, being larger than a given threshold.

Further in accordance with an embodiment of the present disclosure the packets are remote direct memory access (RDMA) packets.

Still further in accordance with an embodiment of the present disclosure the packets are remote direct memory access (RDMA) over converged Ethernet (RoCE) version 2 (v2) packets.

There is also provided in accordance with still another embodiment of the present disclosure, a system including a requester device, including a network interface to send packets with packet sequence numbers to a responder device over a network, and packet processing circuitry, and the responder device, including a network interface to receive some packets of the packets transmitted from the requester device, and packet processing circuitry to collect information about the packet sequence numbers of the packets that have been received from the requester device, generate a selective acknowledgement including an indication of the packet sequence numbers of at least one packet of the packets that has been received, and at least one other packet of the packets that has not been received by the responder device from the requester device, wherein the at least one packet that has been received by the responder device includes at least one of the packets received out-of-order the packet sequence numbers, and send the selective acknowledgement to the requester device via the network interface, wherein the packet processing circuitry of the requester device is to receive from the responder device the selective acknowledgement, analyze the selective acknowledgement to determine a status of a given packet that has not yet been received by the responder device, and retransmit to the responder device via the network interface the given packet based on the analysis of the selective acknowledgement.

Additionally in accordance with an embodiment of the present disclosure the packet processing circuitry of the responder device is to include a bitmap in the selective acknowledgement to indicate the packet sequence numbers of the at least one packet that has been received and the at least one other packet that has not been received by the responder device from the requester device, and include an indication of a base packet sequence number of one of the packets in the selective acknowledgement from which the packet sequence numbers of the packets indicated by the bitmap are derived, and the packet processing circuitry of the requester device is to derive the packet sequence numbers of the packets indicated by the bitmap from the base packet sequence number, and analyze the bitmap to identify the packet sequence numbers of the at least one packet that has been received and the at least one other packet that has not been received by the responder device from the requester device.

Moreover, in accordance with an embodiment of the present disclosure the packet processing circuitry of the responder device is to include a packet sequence number list and/or at least one packet sequence number range in the selective acknowledgement to indicate the packet sequence numbers of the at least one packet that has been received and the at least one other packet that has not been received by the responder device from the requester device.

Further in accordance with an embodiment of the present disclosure the packet processing circuitry of the responder device is to collect information about the arrival times of the packets, and include at least one of the arrival times in the selective acknowledgement, and the packet processing circuitry of the requester device is to analyze the at least one arrival time to determine the status of the given packet that has not yet been received by the responder device from the requester device.

Still further in accordance with an embodiment of the present disclosure the packets are remote direct memory access (RDMA) packets.

Additionally in accordance with an embodiment of the present disclosure the packets are remote direct memory access (RDMA) over converged Ethernet (RoCE) version 2 (v2) packets.

Moreover, in accordance with an embodiment of the present disclosure the packet processing circuitry of the requester device is to analyze the selective acknowledgement and estimate that the given packet that has not yet been received by the responder device from the requester device has been dropped based on the given packet being transmitted via a same path in the network to another one of the packets indicated as having been received by the responder device from the requester device in the selective acknowledgement.

Further in accordance with an embodiment of the present disclosure the packet processing circuitry of the requester device is to analyze the selective acknowledgement and estimate that the given packet that has not yet been received by the responder device from the requester device has been dropped, based on age of the given packet on the network.

Still further in accordance with an embodiment of the present disclosure the packet processing circuitry of the requester device is to analyze the selective acknowledgement and estimate that the given packet that has not yet been received by the responder device from the requester device has been dropped, based on a difference between (a) a transmission time of the given packet, and (b) a transmission time of another one of the packets indicated as having been received by the responder device from the requester device in the selective acknowledgement, being larger than a threshold time period.

Additionally in accordance with an embodiment of the present disclosure the packet processing circuitry of the requester device is to analyze the selective acknowledgement and estimate that the given packet that has not yet been received by the responder device from the requester device has been dropped, based on a difference between (a) a packet sequence number of the given packet, and (b) a packet sequence number of another one of the packets indicated as having been received by the responder device from the requester device in the selective acknowledgement, being larger than a given threshold.

There is also provided in accordance with still another embodiment of the present disclosure, a method, including sending packets with packet sequence numbers to a responder device over a network, receiving from the responder device a selective acknowledgement including an indication of the packet sequence numbers of at least one packet of the packets that has been received, and at least one other packet of the packets that has not been received by the responder device from the requester device, wherein the at least one packet that has been received by the responder device includes at least one of the packets received out-of-order the packet sequence numbers, analyzing the selective acknowledgement to determine a status of a given packet that has not yet been received by the responder device, and retransmitting to the responder device the given packet based on the analysis of the selective acknowledgement.

There is also provided in accordance with still another embodiment of the present disclosure, a method, including sending packets with packet sequence numbers to a responder device over a network, receiving some packets of the packets transmitted from a requester device, collecting information about the packet sequence numbers of the packets that have been received from the requester device, generating a selective acknowledgement including an indication of the packet sequence numbers of at least one packet of the packets that has been received, and at least one other packet that has not been received by the responder device from the requester device, wherein the at least one packet that has been received by the responder device includes at least one of the packets received out-of-order the packet sequence numbers, sending the selective acknowledgement to the requester device, receiving from the responder device the selective acknowledgement, analyzing the selective acknowledgement to determine a status of a given packet that has not yet been received by the responder device, and retransmitting to the responder device the given packet based on the analysis of the selective acknowledgement.

### BRIEF DESCRIPTION OF THE DRAWINGS

The present disclosure will be understood from the following detailed description, taken in conjunction with the drawings in which:

FIG. 1 is a block diagram view of a computer system constructed and operative in accordance with an embodiment of the present disclosure;

FIG. 2 is a flowchart including steps in a method of operation of a responder device in the system of FIG. 1;

FIG. 3 is a schematic view of a selective acknowledgment for use in the system of FIG. 1;

FIG. 4 is a flowchart including steps in a method of operation of a requester device in the system of FIG. 1; and

FIG. 5 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

### OVERVIEW OF EXAMPLE EMBODIMENTS

In byte-stream based transport protocols, such as Transmission Control Protocol (TCP), mechanisms exist to acknowledge received packets as byte-ranges and prompt retransmission of missing byte-ranges. However, message-based transport streams, such as remote direct memory access (RDMA), face difficulties in utilizing these mechanisms in lossy networks. The cumulative acknowledgment approach, which acknowledges the arrival of several packets received in order, does not provide information about out-of-order packets or packets that have not been received between arrived out-of-order packets.

Current systems, in particular those supporting multipathing (i.e., sending packets of the same flow over different paths over the network), struggle to distinguish between dropped packets and delayed packets, resulting in inefficiencies in data transmission and processing. The system may need to wait a certain period before determining that a packet has been lost. This limitation necessitates a more efficient method for tracking and managing packet streams, particularly in environments where packet loss is more prevalent.

Therefore, embodiments of the present disclosure address at least some of the above drawbacks by improving the efficiency of packet retransmission in lossy network environments by utilizing a Selective Acknowledgment (SACK) mechanism. A requester device sends packets with packet sequence numbers to a responder device. The responder device collects detailed information about the received packets, including those received out-of-order, and generates a SACK that indicates which packet or packets have been received and which have not. This SACK may include a bitmap to represent the status of the packets and may also include the arrival times of the packets. The responder device sends the SACK to the requester device.

The requester device receives the SACK and analyzes it to determine the status of the missing packet(s). Based on this analysis, the requester can make informed decisions about retransmitting specific packets. The requester can use various algorithmic mechanisms, such as considering the paths taken by the packets, the transmission times, and the sequence numbers, to estimate whether a packet is delayed or dropped and decide on the appropriate retransmission actions.

As the requester device may have access to data that the responder does not, such as state data saved by the requester device, e.g., paths taken by the packets, and transmission times of the packets, the requester device has more complete information upon which retransmission decisions can be made. For example, the requester device may have a better understanding of whether a given packet is likely delayed or dropped and make an appropriate decision regarding retransmission.

This method allows for more accurate and efficient tracking and management of packet streams, leading to better handling of packet loss, ultimately improving the overall performance of the network communication system.

### System Description

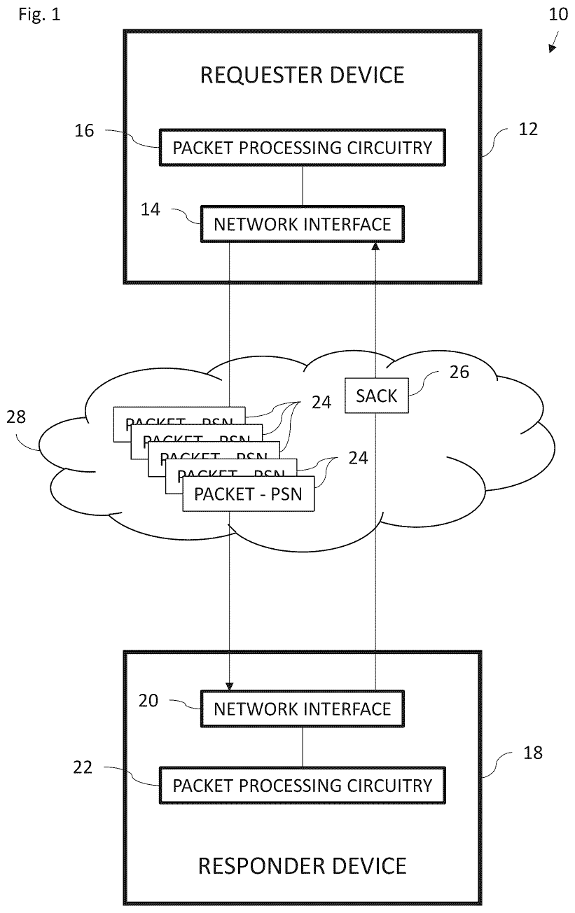

Reference is now made to FIG. 1, which is a block diagram view of a computer system 10 constructed and operative in accordance with an embodiment of the present disclosure. The system 10 includes a requester device 12. The requester device 12 may be any suitable device, for example, a network device, such as a network interface controller (NIC), a network switch, or a data processing unit (DPU), or an endpoint device including a host device connected to a network device. The requester device 12 includes a network interface 14, and packet processing circuitry 16.

The system 10 also includes a responder device 18. The responder device 18 may be any suitable device, for example, a network device, such as a network interface controller (NIC), a network switch, or a data processing unit (DPU), or an endpoint device including a host device connected to a network device. The responder device 18 includes a network interface 20, and packet processing circuitry 22.

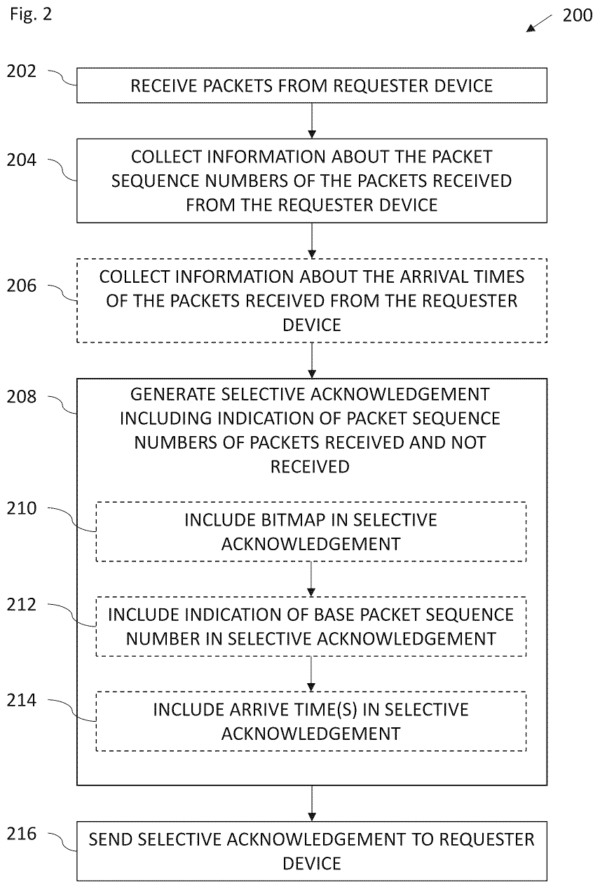

The requester device 12 is configured to send packets 24 over a network 28 to responder device 18. Each packet 24 has a packet sequence number (PSN) which uniquely identifies the packet 24. The responder device 18 receives some of the packets, because some of the packets are dropped. The responder device 18 intermittently generates a selective acknowledgement 26 which indicates the packets that have been recently received and not yet received, according to PSN, and sends the selective acknowledgement 26 to requester device 12 to analyze, as described in more detail with reference to FIGS. 2-4.

The packets may be any suitable packets constructed according to any suitable protocol(s). In some embodiments, the packets 24 are remote direct memory access (RDMA) packets. In other embodiments, the packets 24 are remote direct memory access (RDMA) over converged Ethernet (ROCE) version 2 (v2) packets.

Reference is now made to FIG. 2, which is a flowchart 200 including steps in a method of operation of responder device 18 in the system 10 of FIG. 1. The network interface 20 of responder device 18 is configured to receive some packets 24 of a stream of packets transmitted from requester device 12 according to packet sequence numbers (block 202). The PSNs are assigned sequentially to the packets by requester device 12. The packet processing circuitry 22 of responder device 18 is configured to collect information about the packet sequence numbers of the packets 24 that have been received from the requester device 12, including the packets received out-of-order according to the packet sequence numbers (block 204). For example, a packet with PSN equal to 5 may be received before a packet with PSN equal to 4 or 3. In some embodiments, the packet processing circuitry 22 of responder device 18 is configured to collect information about the arrival times of the packets 24 (block 206).

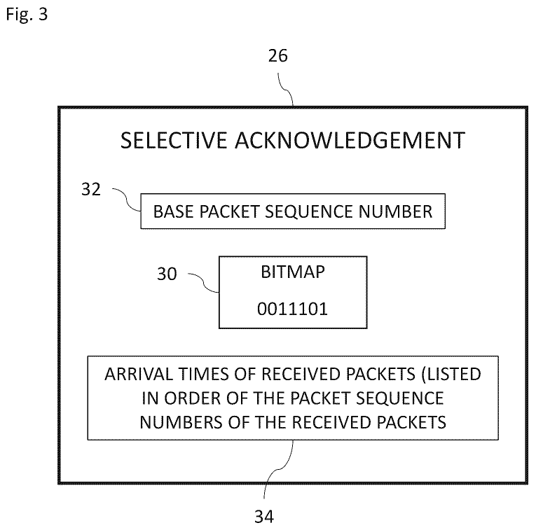

Reference is now made to FIG. 3, which is a schematic view of selective acknowledgment 26 for use in the system 10 of FIG. 1. Reference is also made to FIG. 2. The packet processing circuitry 22 of responder device 18 is configured to generate selective acknowledgement 26 including an indication of the packet sequence numbers of the packet or packets 24 that have been received and the packet or packets that have not been received by the responder device 18 from the requester device 12, including at least one of the packets 24 received out-of-order according to the packet sequence numbers (block 208). The selective acknowledgement 26 may indicate one or more packets that have been received, and one or more packets that have not been received. The selective acknowledgement 26 typically indicates a subset of the packets sent in the stream of packets by the requester device 12 to responder device 18. For example, the responder device 18 may generate selective acknowledgement 26 to include an indication of the arrival status of packets 5 to 10, and then at a later time generate another selective acknowledgement 26 to include an indication of the arrival status of packets 7 to 15. In some embodiments, the selective acknowledgement 26 may be generated periodically and provide indications of all the packets received by responder device 18 since the last selective acknowledgement 26 was generated. In some embodiments, the selective acknowledgement 26 may be generated after a given number of packets are received by the responder device 18 and provide indications of all the packets received by responder device 18 since the last selective acknowledgement 26 was generated. Since the selective acknowledgement 26 also indicates packets received out-of-order and missing packets, a given selective acknowledgement 26 may indicate packets already indicated as received or missing in a previous selective acknowledgement 26 for the sake of completeness. For example, if a selective acknowledgement 26 indicates that packets 6 and 8 were received and packet 7 is missing, at a later time, when packet 7 is received the next selective acknowledgement 26 may indicate that packet 7 and 8 have been received as well as data about packets 9 and 10, for example.

The packet processing circuitry 22 of responder device 18 is configured to include a bitmap 30 in the selective acknowledgement 26 to indicate the packet sequence numbers of the packet or packets 24 that have been received and the packet or packets that have not been received by the responder device 18 from the requester device 12 (block 210). The example bitmap provided in FIG. 3 shows that the first two packets identified by the bitmap 30 were not received (indicated by two zeros), the next three packets identified by bitmap 30 were received (indicated by three ones), the next packet identified by bitmap 30 was not received (indicated by a zero), and the next packet identified by bitmap 30 was received (indicated by a one).

The packet processing circuitry 22 of responder device 18 is configured to include an indication of a base packet sequence number 32 of the packets indicated in the selective acknowledgement 26 from which the packet sequence numbers of the packets indicated by the bitmap 30 are derived (block 212). For example, if the base packet sequence number 32 is equal to 10 then the base packet sequence number 32 may indicate that the packet with PSN equal to 10 has been received by responder device 18, and the bitmap 30 indicates the status of packets with PSNs from 11 to 17. In some embodiments, the base packet sequence number 32 may indicate the PSN of the first PSN indicated by the bitmap 30 so in the example of FIG. 3, the bitmap 30 indicates the status of packets with PSNs from 10-16.

In some embodiments, the packet processing circuitry 22 of responder device 18 is configured to include a packet sequence number list and/or one or more packet sequence number ranges in the selective acknowledgement 26 to indicate the packet sequence numbers of the packet(s) that has been received and the packet(s) that has not been received by the responder device 18 from the requester device 12. For example, if packets with PSNs 5-20 excluding PSN 13 have been received, the selective acknowledgement 26, may list all the PSNs from 5 until 12 and all the PSNs from 14 until PSN 20, or may list a range of PSNs from 5 to 12 and another range from 14 to 20.

The packet processing circuitry 22 of responder device 18 is configured to include the one or more arrival times 34 in the selective acknowledgement 26 (block 214). The arrival time(s) 34 generally correspond to the arrival time(s) of the packet(s) indicated in the bitmap 30 and optionally the packet of the base packet sequence number 32. The arrival times 34 are generally listed in the order of the packets that have been received by the responder device 18 and indicated as received in the selective acknowledgement 26. The packet processing circuitry 22 of responder device 18 is configured to send the selective acknowledgement 26 to the requester device 12 via the network interface 20 (block 216).

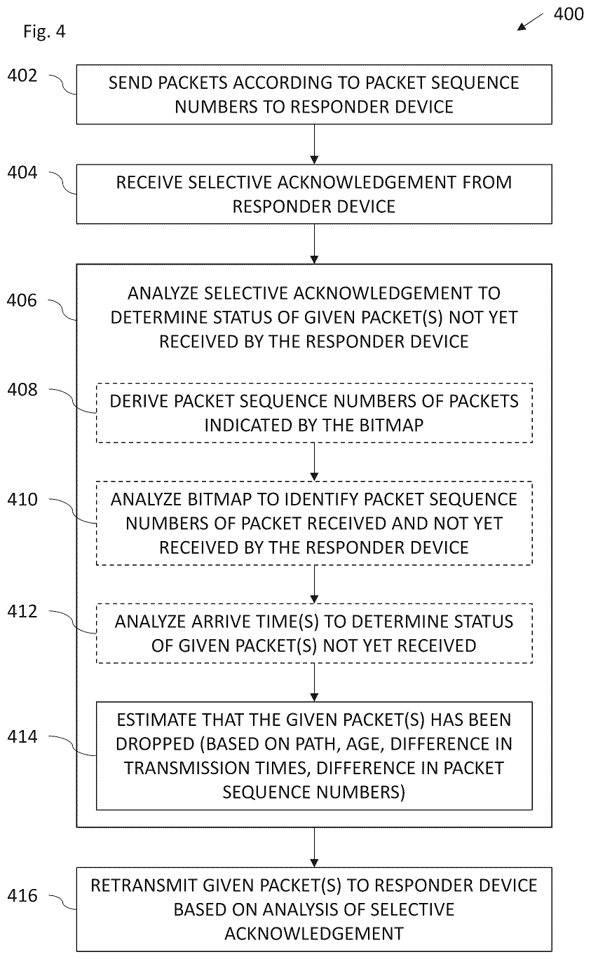

Reference is now made to FIG. 4, which is a flowchart 400 including steps in a method of operation of requester device 12 in the system 10 of FIG. 1. The network interface 14 of requester device 12 is configured to send packets 24 according to packet sequence numbers to responder device 18 over network 28 (block 402). The packet processing circuitry 16 of requester device 12 is configured to receive from the responder device 18 the selective acknowledgement 26 including an indication of the packet sequence numbers of the packet or packets 24 that have been received and the packet or packets that have not been received by the responder device 18 from the requester device 12, including at least one of the packets 24 received out-of-order according to the packet sequence numbers (block 404). The packet processing circuitry 16 of requester device 12 is configured to analyze the selective acknowledgement 26 to determine a status of a given packet (or packets) that has not yet been received by the responder device 18 (block 406). The packet processing circuitry 16 of requester device 12 is configured to retransmit to the responder device 18 via the network interface 20 the given packet(s) based on the analysis of the selective acknowledgement 26 (block 416).

The step of block 406 is now described in more detail. In some embodiments, the packet processing circuitry 16 of requester device 12 is configured to derive the packet sequence numbers of the packets 24 indicated by the bitmap 30 from the base packet sequence number 32 (block 408). In some embodiments, the packet processing circuitry 16 of requester device 12 is configured to analyze the bitmap 30 to identify the packet sequence numbers of the packet(s) 24 that have been received and the packet(s) 24 that have not been received by the responder device 18 from the requester device 12 (block 410). In some embodiments, the packet processing circuitry 16 of requester device 12 is configured to analyze the arrival time(s) 34 (included in the selective acknowledgement 26) to determine the status of the given packet(s) that has not yet been received by the responder device 18 from the requester device 12 (block 412). In some embodiments, the packet processing circuitry 16 of requester device 12 is configured to estimate that the given packet has been dropped based on various criteria (block 414), discussed in more detail below.

In some embodiments, the packet processing circuitry 16 of requester device 12 is configured to analyze the selective acknowledgement 26 and estimate that the given packet that has not yet been received by the responder device 18 from the requester device 12 has been dropped based on the given packet being transmitted via a same path in the network to another one of the packets 24 indicated as having been received by the responder device 18 from the requester device 12 in the selective acknowledgement 26. The requester device 12 may track the paths used by each of the packets 24 or know that alternate packets are sent down alternate routes, for example, or have some other mechanism to determine if the given packet was transmitted along the same path as one or more received packets 24 (indicated as received in the selective acknowledgement 26) and therefore the given packet should have been received before the other received packet(s) (indicated as received in the selective acknowledgement 26) and therefore the given packet may be presumed to have been dropped along that same path.

In some embodiments, the packet processing circuitry 16 of requester device 12 is configured to analyze the selective acknowledgement 26 and estimate that the given packet that has not yet been received by the responder device 18 from the requester device 12 has been dropped, based on age of the given packet on the network 28. The requester device 12 may track the transmission times of the sent packets 24, and based on the age of the given packet (derived from the tracked transmission time of the given packet), the requester device 12 may determine that the age of the given packet is greater than a maximum age (based on the expected transmission time of the given packet over the network) and therefore the given packet has been dropped and should be retransmitted to responder device 18.

In some embodiments, the packet processing circuitry 16 of requester device 12 is configured to analyze the selective acknowledgement 26 and estimate that the given packet that has not yet been received by the responder device 18 from the requester device 12 has been dropped, based on a difference between: (a) a transmission time of the given packet; and (b) a transmission time of another one of the packets indicated as having been received by the responder device 18 from the requester device 12 in the selective acknowledgement 26, being larger than a threshold time period.

In some embodiments, the packet processing circuitry 16 of requester device 12 is configured to analyze the selective acknowledgement 26 and estimate that the given packet that has not yet been received by the responder device 18 from the requester device 12 has been dropped, based on a difference between: (a) a packet sequence number of the given packet; and (b) a packet sequence number of another one of the packets indicated as having been received by the responder device 18 from the requester device 12 in the selective acknowledgement 26, being larger than a given threshold.

In practice, some or all of these functions of packet processing circuitry 16, 22 may be combined in a single physical component or, alternatively, implemented using multiple physical components. These physical components may comprise hard-wired or programmable devices, or a combination of the two. In some embodiments, at least some of the functions of the packet processing circuitry 16, 22 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

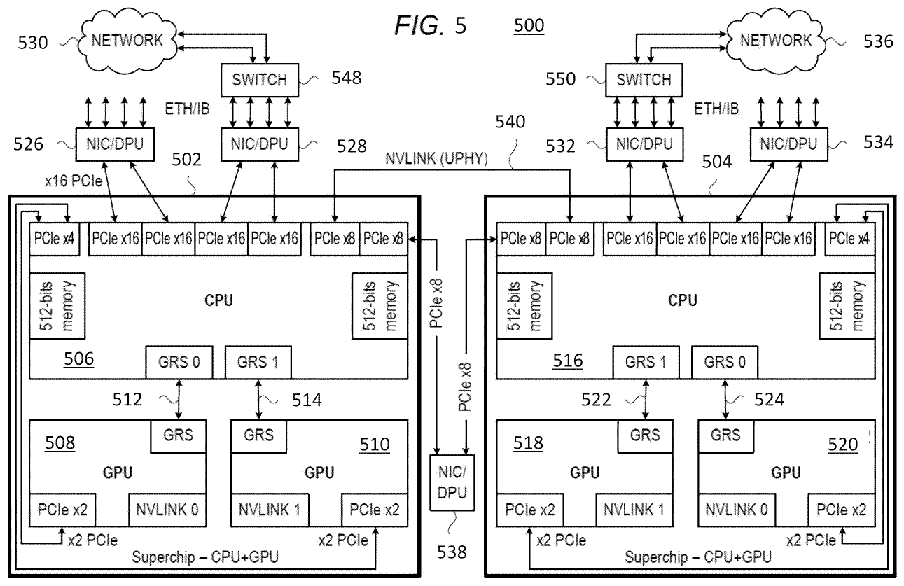

Reference is now made to FIG. 5, which is a block diagram that schematically illustrates a computing system 500, e.g., a data center or a High-Performance Computing (HPC) cluster, in accordance with an embodiment of the present disclosure. The requester device 12 and network interface 14 may be implemented as any suitable device in the computing system 500.

System 500 comprises a plurality of subsystems, e.g. multiple processing devices coupled to each other, multiple network devices, and multiple networks, according to at least one embodiment. Computing system 500 is designed with multiple integrated circuits (referred to as processing devices), where each integrated circuit can include one or more CPUs and GPUs, forming a powerful and flexible architecture.

The various processing devices are interconnected via an NVLink or other high-speed interconnect (e.g., Ethernet), enabling high-speed communication between the subsystems, and are also connected through a NIC or DPU to ensure efficient data transfer across computing system 500 and to one or more external networks 530, 536. In the present example, system 500 comprises a packet switch 548 that connects NIC/DPU 528 to network 530, and a packet switch 550 that connects NIC/DPU 532 to network 536.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 500 can include one or more CPUs and one or more GPUs.

FIG. 5 also demonstrates an example architecture of a multi-GPU architecture. As illustrated in the figure, computing system 500 includes a processing device 502 with a multi-GPU architecture. In particular, processing device 502 may be a system-on-chip and includes multiple subsystems such as a CPU 506, a GPU 508, and a GPU 510. CPU 506 can be coupled to GPU 508 via a die-to-die (D2D) or chip-to-chip (C2C) interconnect 512, such as a Ground-Referenced Signaling interconnect (GRS interconnect). CPU 506 can be coupled to GPU 510 via a D2D or C2C interconnect 514. CPU 506 can also couple to GPU 508 and GPU 510 via PCIe interconnects.

CPU 506 can be coupled to one or more NICs or DPUs, which are coupled to one or more networks. For example, as illustrated in FIG. 5, CPU 506 is coupled to a first NIC/DPU 526, which is coupled to a network 530. CPU 506 is also coupled to a second NIC/DPU 528, which is coupled to network 530 via switch 548. NIC/DPU 526 and NIC/DPU 528 can be coupled to network 530 over Ethernet (ETH), NVLINK or InfiniBand (IB) connections, for example.

Computing system 500 also includes a processing device 504 with a multi-GPU architecture. In particular, processing device 504 includes multiple subsystems including a CPU 516, a GPU 518, and a GPU 520. CPU 516 can be coupled to GPU 518 via a D2D or C2C interconnect 522. CPU 516 can be coupled to GPU 520 via a D2D or C2C interconnect 524. CPU 516 can also couple to GPU 518 and GPU 520 via PCIe interconnects. CPU 516 can be coupled to one or more NICs or DPUs, which are coupled to one or more networks. For example, as illustrated in FIG. 5, CPU 516 is coupled to a first NIC/DPU 532, which is coupled to a network 536. CPU 516 is also coupled to a second NIC/DPU 534, which is coupled to network 536 via switch 550. NIC/DPU 532 and NIC/DPU 534 can be coupled to network 536 over Ethernet (ETH), NVLINK or InfiniBand (IB) connections.

In at least one embodiment, processing device 502 and processing device 504 can communicate with each other via a NIC/DPU 538, such as over PCIe interconnects. Processing device 502 and processing device 504 can also communicate with each other over a high-bandwidth communication interconnect 540, such as an NVLink interconnect or other high-speed interconnects. The packet switches in FIG. 5 may comprise, for example, Nvidia Quantum-2 switches. The NICs/DPUs in the figure may comprise, for example, Nvidia Bluefield DPUs.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A responder device, comprising:
a network interface to receive packets of a stream of packets transmitted from a requester device with packet sequence numbers; and
packet processing circuitry to:
collect information about the packet sequence numbers of the packets that have been received from the requester device;
generate a selective acknowledgement including an indication of the packet sequence numbers of: at least one packet of the packets that has been received; and at least one other packet of the packets that has not been received by the responder device from the requester device, wherein the at least one packet that has been received by the responder device includes at least one of the packets received out-of-order according to the packet sequence numbers; and
send the selective acknowledgement to the requester device via the network interface.

2. The device according to claim 1, wherein the packet processing circuitry is to:
include a bitmap in the selective acknowledgement to indicate the packet sequence numbers of the at least one packet that has been received and the at least one other packet that has not been received by the responder device from the requester device; and
include an indication of a base packet sequence number of one of the packets in the selective acknowledgement from which the packet sequence numbers of the packets indicated by the bitmap are derived.

3. The device according to claim 1, wherein the packet processing circuitry is to include a packet sequence number list and/or at least one packet sequence number range in the selective acknowledgement to indicate the packet sequence numbers of the at least one packet that has been received and the at least one other packet that has not been received by the responder device from the requester device.

4. The device according to claim 1, wherein the packet processing circuitry is to collect information about the arrival times of the received packets, and include the at least one of the arrival times in the selective acknowledgement.

5. The device according to claim 1, wherein the packets are remote direct memory access (RDMA) packets.

6. The device according to claim 1, wherein the packets are remote direct memory access (RDMA) over converged Ethernet (ROCE) version 2 (v2) packets.

7. A requester device, comprising:
a network interface to send packets with packet sequence numbers to a responder device over a network; and
packet processing circuitry to:
receive from the responder device a selective acknowledgement including an indication of the packet sequence numbers of: at least one packet of the packets that has been received; and at least one other packet of the packets that has not been received by the responder device from the requester device, wherein the at least one packet that has been received by the responder device includes at least one of the packets received out-of-order according to the packet sequence numbers;
analyze the selective acknowledgement to determine a status of a given packet that has not yet been received by the responder device; and
retransmit to the responder device via the network interface the given packet based on the analysis of the selective acknowledgement.

8. The device according to claim 7, wherein:
the selective acknowledgement includes a bitmap to indicate the packet sequence numbers of the at least one packet that has been received and the at least one other packet that has not been received by the responder device from the requester device;
the selective acknowledgement indicates of a base packet sequence number of one of the packets;
the packet processing circuitry is to derive the packet sequence numbers of the packets indicated by the bitmap from the base packet sequence number; and
the packet processing circuitry is to analyze the bitmap to identify the packet sequence numbers of the at least one packet that has been received and the at least one other packet that has not been received by the responder device from the requester device.

9. The device according to claim 7, wherein the selective acknowledgement includes a packet sequence number list and/or at least one packet sequence number range in the selective acknowledgement to indicate the packet sequence numbers of the at least one packet that has been received and the at least one other packet that has not been received by the responder device from the requester device.

10. The device according to claim 7, wherein:
the selective acknowledgment includes at least one arrival time of at least one of the packets; and
the packet processing circuitry is to analyze the at least one arrival time to determine the status of the given packet that has not yet been received by the responder device from the requester device.

11. The device according to claim 7, wherein the packet processing circuitry is to analyze the selective acknowledgement and estimate that the given packet that has not yet been received by the responder device from the requester device has been dropped based on the given packet being transmitted via a same path in the network to another one of the packets indicated as having been received by the responder device from the requester device in the selective acknowledgement.

12. The device according to claim 7, wherein the packet processing circuitry is to analyze the selective acknowledgement and estimate that the given packet that has not yet been received by the responder device from the requester device has been dropped, based on age of the given packet on the network.

13. The device according to claim 7, wherein the packet processing circuitry is to analyze the selective acknowledgement and estimate that the given packet that has not yet been received by the responder device from the requester device has been dropped, based on a difference between: (a) a transmission time of the given packet; and (b) a transmission time of another one of the packets indicated as having been received by the responder device from the requester device in the selective acknowledgement, being larger than a threshold time period.

14. The device according to claim 7, wherein the packet processing circuitry is to analyze the selective acknowledgement and estimate that the given packet that has not yet been received by the responder device from the requester device has been dropped, based on a difference between: (a) a packet sequence number of the given packet; and (b) a packet sequence number of another one of the packets indicated as having been received by the responder device from the requester device in the selective acknowledgement, being larger than a given threshold.

15. The device according to claim 7, wherein the packets are remote direct memory access (RDMA) packets.

16. The device according to claim 7, wherein the packets are remote direct memory access (RDMA) over converged Ethernet (ROCE) version 2 (v2) packets.

17. A system comprising:
a requester device, comprising:
a network interface to send packets with packet sequence numbers to a responder device over a network; and
packet processing circuitry; and
the responder device, comprising:
a network interface to receive some packets of the packets transmitted from the requester device; and
packet processing circuitry to: collect information about the packet sequence numbers of the packets that have been received from the requester device; generate a selective acknowledgement including an indication of the packet sequence numbers of: at least one packet of the packets that has been received; and at least one other packet of the packets that has not been received by the responder device from the requester device, wherein the at least one packet that has been received by the responder device includes at least one of the packets received out-of-order according to the packet sequence numbers; and send the selective acknowledgement to the requester device via the network interface, wherein the packet processing circuitry of the requester device is to:
receive from the responder device the selective acknowledgement;
analyze the selective acknowledgement to determine a status of a given packet that has not yet been received by the responder device; and
retransmit to the responder device via the network interface the given packet based on the analysis of the selective acknowledgement.

18. The device according to claim 17, wherein:
the packet processing circuitry of the responder device is to:
include a bitmap in the selective acknowledgement to indicate the packet sequence numbers of the at least one packet that has been received and the at least one other packet that has not been received by the responder device from the requester device; and
include an indication of a base packet sequence number of one of the packets in the selective acknowledgement from which the packet sequence numbers of the packets indicated by the bitmap are derived; and
the packet processing circuitry of the requester device is to:
derive the packet sequence numbers of the packets indicated by the bitmap from the base packet sequence number; and
analyze the bitmap to identify the packet sequence numbers of the at least one packet that has been received and the at least one other packet that has not been received by the responder device from the requester device.

19. The device according to claim 17, wherein the packet processing circuitry of the responder device is to include a packet sequence number list and/or at least one packet sequence number range in the selective acknowledgement to indicate the packet sequence numbers of the at least one packet that has been received and the at least one other packet that has not been received by the responder device from the requester device.

20. The device according to claim 17, wherein:
the packet processing circuitry of the responder device is to:
collect information about the arrival times of the packets; and
include at least one of the arrival times in the selective acknowledgement; and
the packet processing circuitry of the requester device is to analyze the at least one arrival time to determine the status of the given packet that has not yet been received by the responder device from the requester device.

21. The device according to claim 17, wherein the packets are remote direct memory access (RDMA) packets.

22. The device according to claim 17, wherein the packets are remote direct memory access (RDMA) over converged Ethernet (ROCE) version 2 (v2) packets.

23. The device according to claim 17, wherein the packet processing circuitry of the requester device is to analyze the selective acknowledgement and estimate that the given packet that has not yet been received by the responder device from the requester device has been dropped based on the given packet being transmitted via a same path in the network to another one of the packets indicated as having been received by the responder device from the requester device in the selective acknowledgement.

24. The device according to claim 17, wherein the packet processing circuitry of the requester device is to analyze the selective acknowledgement and estimate that the given packet that has not yet been received by the responder device from the requester device has been dropped, based on age of the given packet on the network.

25. The device according to claim 17, wherein the packet processing circuitry of the requester device is to analyze the selective acknowledgement and estimate that the given packet that has not yet been received by the responder device from the requester device has been dropped, based on a difference between: (a) a transmission time of the given packet; and (b) a transmission time of another one of the packets indicated as having been received by the responder device from the requester device in the selective acknowledgement, being larger than a threshold time period.

26. The device according to claim 17, wherein the packet processing circuitry of the requester device is to analyze the selective acknowledgement and estimate that the given packet that has not yet been received by the responder device from the requester device has been dropped, based on a difference between: (a) a packet sequence number of the given packet; and (b) a packet sequence number of another one of the packets indicated as having been received by the responder device from the requester device in the selective acknowledgement, being larger than a given threshold.

27. A method, comprising:
sending packets with packet sequence numbers to a responder device over a network;
receiving from the responder device a selective acknowledgement including an indication of the packet sequence numbers of: at least one packet of the packets that has been received; and at least one other packet of the packets that has not been received by the responder device from the requester device, wherein the at least one packet that has been received by the responder device includes at least one of the packets received out-of-order according to the packet sequence numbers;
analyzing the selective acknowledgement to determine a status of a given packet that has not yet been received by the responder device; and
retransmitting to the responder device the given packet based on the analysis of the selective acknowledgement.

28. A method, comprising:
sending packets with packet sequence numbers to a responder device over a network;
receiving some packets of the packets transmitted from a requester device;
collecting information about the packet sequence numbers of the packets that have been received from the requester device;
generating a selective acknowledgement including an indication of the packet sequence numbers of: at least one packet of the packets that has been received; and at least one other packet that has not been received by the responder device from the requester device, wherein the at least one packet that has been received by the responder device includes at least one of the packets received out-of-order according to the packet sequence numbers;
sending the selective acknowledgement to the requester device;
receiving from the responder device the selective acknowledgement;
analyzing the selective acknowledgement to determine a status of a given packet that has not yet been received by the responder device; and
retransmitting to the responder device the given packet based on the analysis of the selective acknowledgement.
